(19) United States
(12) Patent Application Publication
(10) Pub. No.: US 2019/0190183 A1
(43) Pub. Date: Jun. 20, 2019

(54) CONNECTION TERMINAL AND CONNECTOR

(71) Applicant: Yazaki Corporation, Tokyo (JP)

(72) Inventors: Hajime KATO, Shizuoka (JP); Shigeo Mori, Shizuoka (JP); Fuminori Sugiyama, Shizuoka (JP); Hiroyuki Tanaka, Shizuoka (JP); Kazuma Watanabe, Shizuoka (JP)

(73) Assignee: Yazaki Corporation, Tokyo (JP)

(21) Appl. No.: 16/223,283

(22) Filed: Dec. 18, 2018

(30) Foreign Application Priority Data
Dec. 20, 2017 (JP) 2017-243323

(51) Int. Cl. H01R 13/20; H01R 13/11

(52) U.S. Cl. CPC H01R 13/20; H01R 13/748; H01R 13/113

(57) ABSTRACT

A connection terminal includes a terminal metal fitting that has first and second electric connection parts each having facing wall surfaces disposed facing each other at an interval and formed in a flat plate shape, and that is electrically connected to an electric connection part of a counterpart connection terminal inserted between first end parts of the first and the second electric connection parts. The terminal metal fitting has a joining part that couples first side end parts of respective second end parts of the first and the second electric connection parts, and an opening restriction part that keeps an interval between the facing wall surfaces of the respective second end parts of the first and the second electric connection parts between second side end parts of the respective second end parts of the first and the second electric connection parts.

### CROSS-REFERENCE TO RELATED APPLICATION(S)

The present application claims priority to and incorporates by reference the entire contents of Japanese Patent Application No. 2017-243323 filed in Japan on Dec. 20, 2017.

### BACKGROUND OF THE INVENTION

### 1. Field of the Invention

The present invention relates to a connection terminal and a connector.

### 2. Description of the Related Art

Conventionally, a connection terminal at least includes a terminal metal fitting. For example, the terminal metal fitting includes two electric connection parts disposed facing each other at an interval. An electric connection part of a counterpart connection terminal is inserted between the two electric connection parts to be engaged. The connection terminal is physically and electrically connected to the counterpart connection terminal, when the two electric connection parts of the connection terminal hold the electric connection part of the counterpart connection terminal therebetween. For example, such a connection terminal is disclosed in Japanese Patent Application Laid-open No. 2012-079545.

In the conventional connection terminal, the electric connection part of the counterpart connection terminal is inserted between the two electric connection parts to be engaged, and the electric connection part of the counterpart connection terminal is extracted from between the two electric connection parts. Consequently, in the conventional connection terminal, to reduce the insertion force of the counterpart connection terminal when the counterpart connection terminal is inserted and engaged, and to reduce the extraction force of the counterpart connection terminal when the counterpart connection terminal is extracted, for example, the electric connection parts are provided with flexibility so as to be able to expand the interval between the two electric connection parts. However, although the connection terminal can reduce the insertion force and the extraction force (hereinafter, referred to as an “insertion and extraction force”) of the counterpart connection terminal, the holding force of the counterpart connection terminal after the counterpart connection terminal is inserted and engaged may not be obtained, because the interval between the two electric connection parts expands too much. The connection terminal configures a connector by being housed in an insulating housing body. In the connector, the interval between the two electric connection parts can be prevented from expanding too much, by providing a locking part and the like for lowering the deflection amount of the electric connection part of the connection terminal in the housing body. However, this may cause problems such as the increased size of the housing body.

### SUMMARY OF THE INVENTION

Consequently, an object of the present invention is to provide a connection terminal and a connector capable of reducing the insertion and extraction force for the counterpart connection terminal and securing the holding force for the counterpart connection terminal using a terminal metal fitting.

A connection terminal according to one aspect of the present invention includes a terminal metal fitting that includes first and second electric connection parts each having facing wall surfaces disposed facing each other at an interval and formed in a flat plate shape, and that is electrically connected to an electric connection part of a counterpart connection terminal inserted between first end parts of the first and the second electric connection parts, wherein the terminal metal fitting includes a joining part that couples first side end parts of respective second end parts of the first and the second electric connection parts, and an opening restriction part that keeps an interval between the facing wall surfaces of the respective second end parts of the first and the second electric connection parts between second side end parts of the respective second end parts of the first and the second electric connection parts.

According to another aspect of the present invention, in the connection terminal, it is preferable that the opening restriction part is formed so as to project from the second side end part of the second end part of the first electric connection part, and lock the second side end part by being hooked to the second side end part of the second end part of the second electric connection part.

According to still another aspect of the present invention, it is preferable that the connection terminal further includes a contact member that is attached to each of the first end parts of the first and the second electric connection parts, and that is capable of being brought into contact with a first wall surface or a second wall surface of the electric connection part of the counterpart connection terminal inserted between the first end parts of the first and the second electric connection parts.

A connector according to still another aspect of the present invention includes a connection terminal; and a housing body that houses the connection terminal in a housing space provided inside, wherein the connection terminal includes a terminal metal fitting that includes first and second electric connection parts each having facing wall surfaces disposed facing each other at an interval and formed in a flat plate shape, and that is electrically connected to an electric connection part of a counterpart connection terminal inserted between first end parts of the first and the second electric connection parts, and the terminal metal fitting includes a joining part that couples first side end parts of respective second end parts of the first and the second electric connection parts, and an opening restriction part that keeps an interval between the facing wall surfaces of the respective second end parts of the first and the second electric connection parts between second side end parts of the respective second end parts of the first and the second electric connection parts.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a connection terminal of an embodiment;

FIG. 2 is an exploded perspective view of the connection terminal of the embodiment viewed from another angle;

FIG. 3 is a perspective view of the connection terminal of the embodiment illustrated with a counterpart connection terminal after the connectors are engaged;

FIG. 4 is an exploded perspective view of a connector of the embodiment;

FIG. 5 is an exploded perspective view of the connector of the embodiment viewed from another angle;

FIG. 6 is a perspective view illustrating the connector before being fitted to a casing of a power supply circuit;

FIG. 7 is a perspective view of the connector of the embodiment illustrated with the counterpart connector before the connectors are engaged;

FIG. 8 is a development view of a terminal metal fitting of the embodiment;

FIG. 9 is a perspective view of the counterpart connector and an electric wire with a connector of the embodiment viewed from another angle;

FIG. 10 is a plan view of the counterpart connector and the electric wire with a connector of the embodiment viewed from a terminal insertion port side;

FIG. 11 is a sectional view cut along line X1-X1 in FIG. 10;

FIG. 12 is an exploded perspective view of the counterpart connector of the embodiment illustrated with an electric wire;

FIG. 13 is a perspective view illustrating a counterpart connection terminal fixed to the electric wire;

FIG. 14 is a perspective view of the counterpart connection terminal fixed to the electric wire viewed from another angle;

FIG. 15 is a plan view of the counterpart connection terminal fixed to the electric wire viewed from a first wall surface side;

FIG. 16 is a side view of the counterpart connection terminal fixed to the electric wire viewed from a first end surface side;

FIG. 17 is an exploded perspective view of a housing body;

FIG. 18 is a perspective view of a second housing member viewed from another angle;

FIG. 19 is a sectional view cut along line Y-Y in FIG. 10;

FIG. 20 is a perspective view of the connector of the embodiment illustrated with the counterpart connector after the connectors are engaged;

FIG. 21 is a sectional view cut along line X2-X2 in FIG. 20; and

FIG. 22 is a perspective view illustrating a variation of the counterpart connection terminal applicable to the connection terminal of the embodiment.

### DETAILED DESCRIPTION OF THE PREFERRED EMBODIMENTS

Hereinafter, an embodiment of a connection terminal and a connector according to the present invention will be described in detail with reference to the accompanying drawings. It is to be noted that the present invention is not limited to the embodiment.

### Embodiment

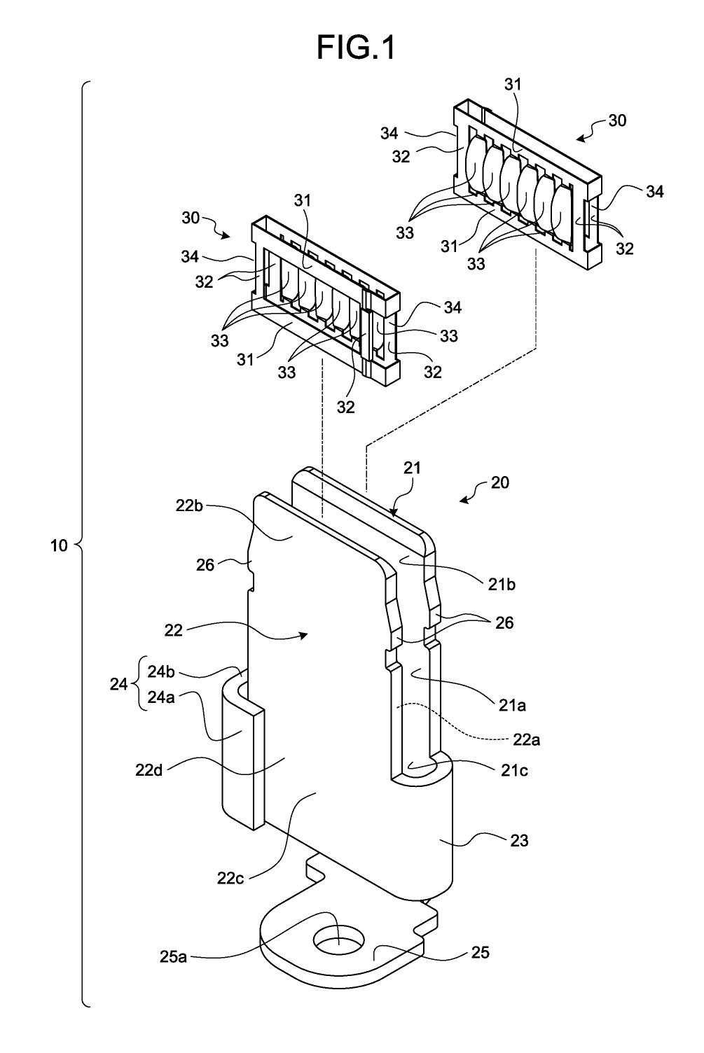

One embodiment of a connection terminal and a connector according to the present invention will be described with reference to FIG. 1 to FIG. 22. In this example, the connection terminal is explained together with a description of the connector including this connection terminal.

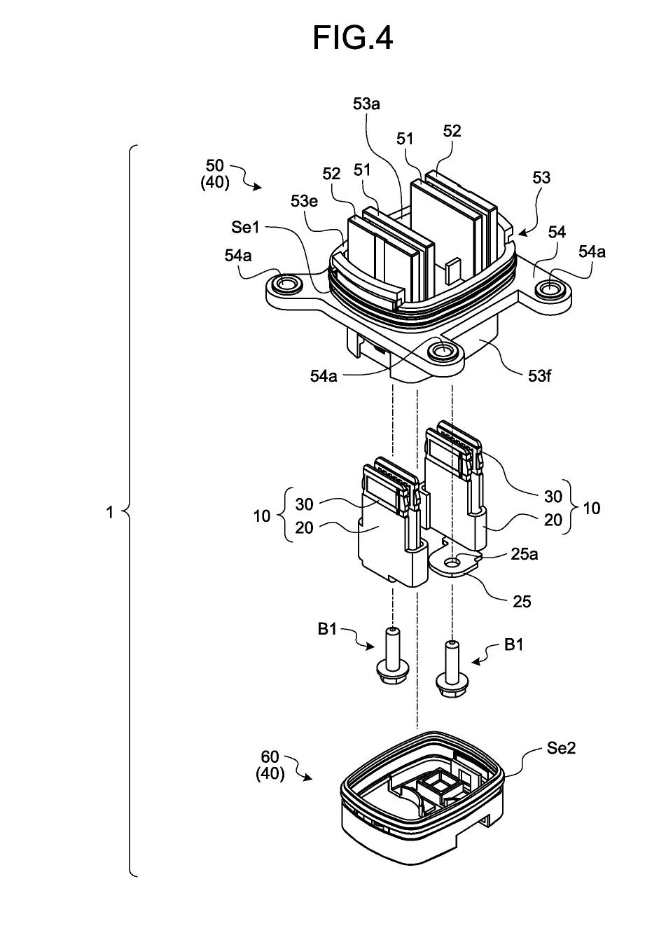

Reference numeral 10 in FIG. 1 to FIG. 5 is the connection terminal of the present embodiment. Reference numeral 1 in FIG. 4 to FIG. 7 is the connector of the present embodiment.

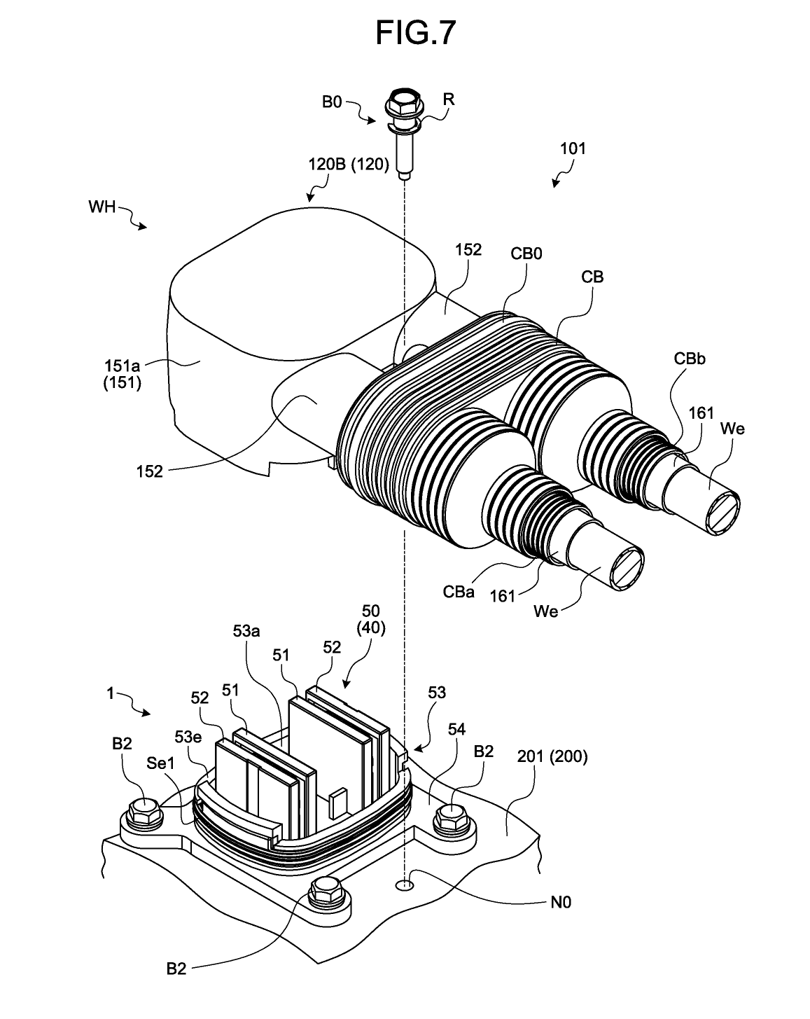

A connector 1 and a counterpart connector 101 (FIG. 7) are components of a connector device. The connector device is a device that electrically couples objects to be connected that are electrically connected to the respective first connector and second connector when the first connector and the second connector are physically and electrically connected. In this example, for the sake of convenience, the connector 1 is referred to as the first connector, and the counterpart connector 101 is referred to as the second connector.

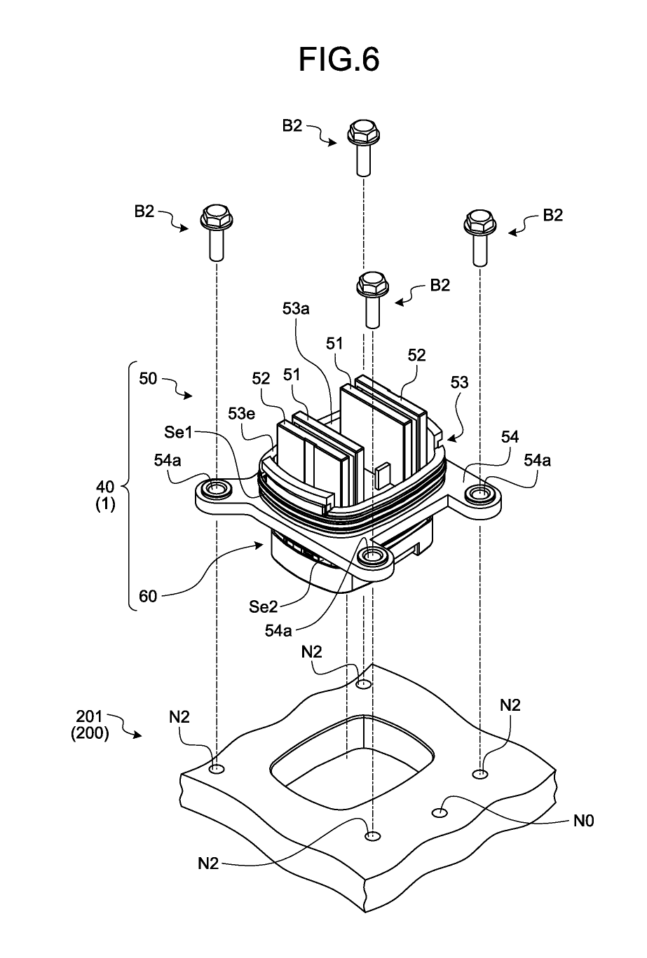

In this example, each of the objects to be connected is a power supply circuit such as an inverter, and an electric apparatus such as a rotating machine, for example. For example, the connector 1 is fitted to a casing 201 of a power supply circuit 200 (FIG. 6 and FIG. 7), and is electrically connected to the power supply circuit 200 via an electric line (not illustrated). The counterpart connector 101 is electrically connected to an electric apparatus (not illustrated) via an electric wire We. The electric apparatus and the power supply circuit 200 can be electrically coupled when the connector 1 and the counterpart connector 101 are electrically connected to each other. Consequently, electricity can be supplied to the electric apparatus from a power supply (secondary battery and the like), and the power supply can be charged with electricity generated by the electric apparatus.

The connector 1 of the present embodiment is electrically connected to the counterpart connector 101 by being inserted into and engaged with the counterpart connector 101. The electric connection between the connector 1 and the counterpart connector 101 is cancelled when the connector 1 is extracted from the counterpart connector 101. In this example, the direction toward which the connector 1 is inserted and engaged is referred to as a “connector insertion direction”, and the direction toward which the connector 1 is extracted is referred to as a “connector extraction direction”. When these two directions are not specified, the directions are referred to as a “connector insertion and extraction direction”. Each direction refers to the direction of the connector 1 relative to the counterpart connector 101 when explanation is made based on the connector 1, and each direction refers to the direction of the counterpart connector 101 relative to the connector 1 when explanation is made based on the counterpart connector 101.

In the present embodiment, the connector 1 is set as a female connector, and the counterpart connector 101 is set as a male connector.

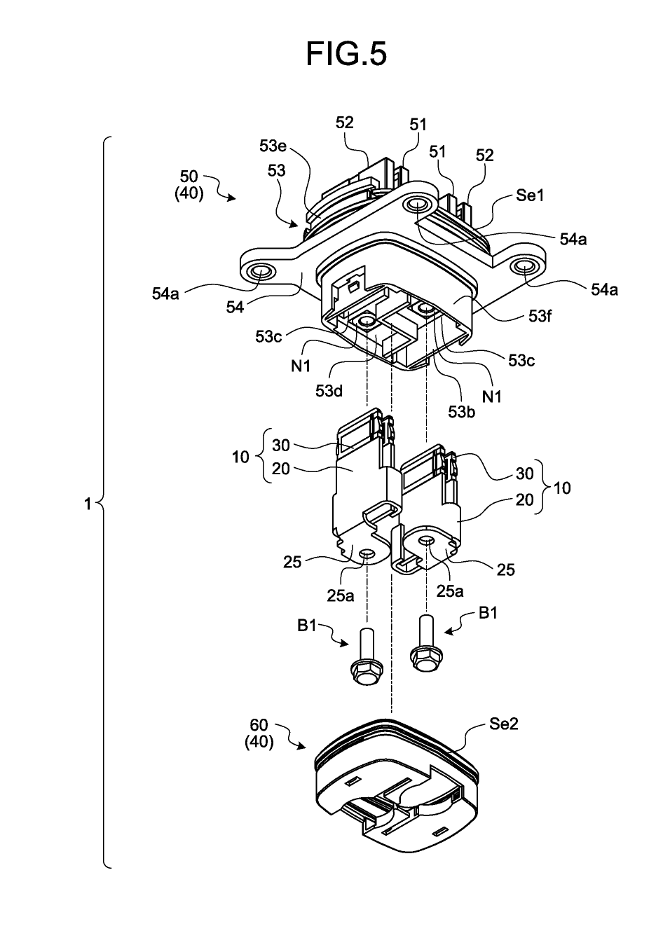

The connector 1 of the present embodiment includes a connection terminal 10 (FIG. 4 and FIG. 5). The connection terminal 10 includes a terminal metal fitting 20 and a contact member 30 (from FIG. 1 to FIG. 5). The connector 1 of the present embodiment also includes a housing body 40 for housing the connection terminal 10 (from FIG. 4 to FIG. 7).

The connection terminal 10 of the present embodiment is electrically connected to a counterpart connection terminal 110, which will be described below, of the counterpart connector 101. In the connection terminal 10 in the example, the terminal metal fitting 20 is electrically connected to the counterpart connection terminal 110 via the contact member 30. For example, the connector 1 of the present embodiment includes the connection terminal 10 for each pole. In this example, two connection terminals 10 are provided (FIG. 4 and FIG. 5).

The terminal metal fitting 20 of the present embodiment is formed of a conductive material such as metal (copper, copper alloy, aluminum, aluminum alloy, and the like) formed into a female shape. In this example, the terminal metal fitting 20 is formed into the female shape by press working such as cutting and bending, using a conductive metal sheet as a base material.

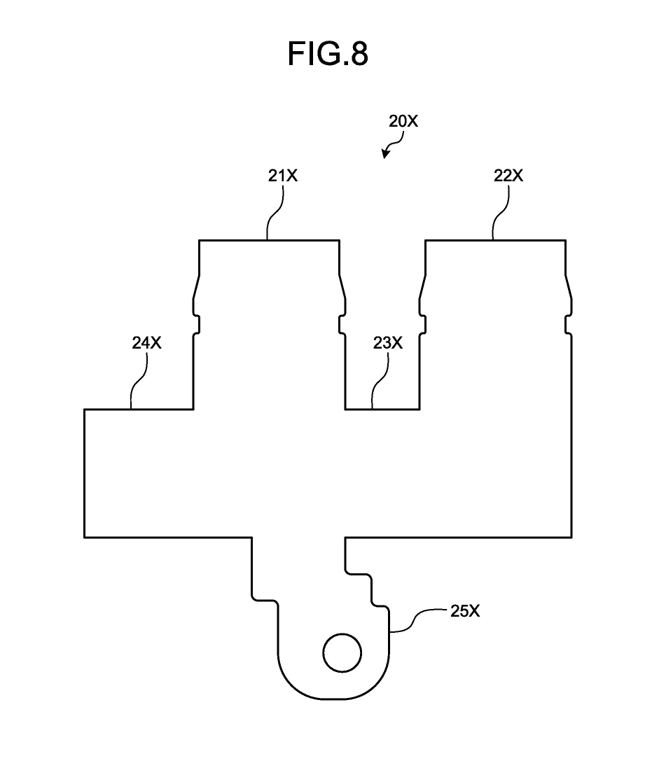

FIG. 8 is a development view of the terminal metal fitting 20. In a terminal metal fitting 20X before being bent, reference numerals 21X and 22X are a first electric connection part and a second electric connection part before being bent, respectively, and are portions to be a first electric connection part 21 and a second electric connection part 22 after being bent, which will be described below. Reference numeral 23X is a joining part before being bent, and is a portion to be a joining part 23 after being bent, which will be described below. Reference numeral 24X is an opening restriction part before being bent, and is a portion to be an opening restriction part 24 after being bent, which will be described below. Reference numeral 25X is a fixed part before being bent, and is a portion to be a fixed part 25 after being bent, which will be described below.

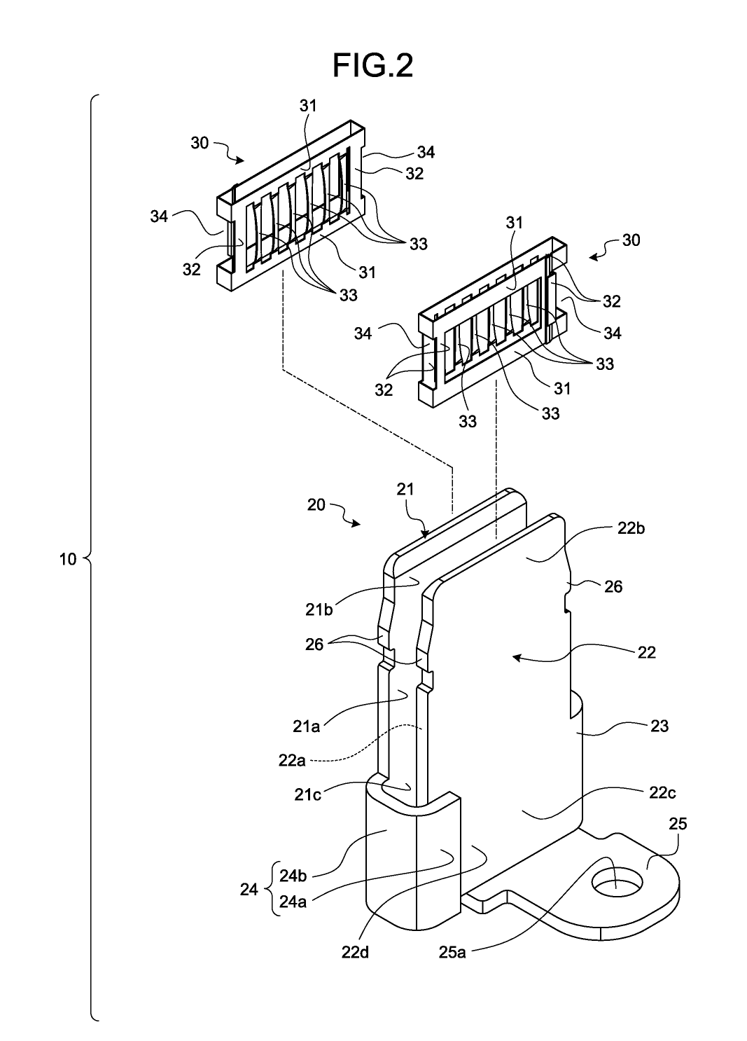

The terminal metal fitting 20 includes the first electric connection part 21 and the second electric connection part 22 disposed facing each other at an interval (from FIG. 1 to FIG. 3). The first electric connection part 21 and the second electric connection part 22 are each formed in a flat plate shape having two flat wall surfaces. In this example, the first electric connection part 21 and the second electric connection part 22 are each formed in a substantially rectangular flat plate shape. Moreover, the first electric connection part 21 and the second electric connection part 22 in the example are both formed in the same shape. In the terminal metal fitting 20, wall surfaces (hereinafter, referred to as “facing wall surfaces) 21a and 22a are disposed facing each other at an interval, the facing wall surface 21a being one of two wall surfaces of the first electric connection part 21 and the facing wall surface 22a being one of two wall surfaces of the second electric connection part 22 (FIG. 1 and FIG. 2). The facing wall surfaces 21a and 22a are disposed facing each other at an interval so as to be in parallel.

In the terminal metal fitting 20, an electric connection part 111, which will be described below, of the counterpart connection terminal 110 is inserted between first end parts 21b and 22b (FIG. 1 and FIG. 2) of the respective first electric connection part 21 and the second electric connection part 22. Consequently, the terminal metal fitting 20 is electrically connected to the inserted electric connection part 111. The first electric connection part 21 and the second electric connection part 22 are formed and disposed so that one of a first wall surface 111a and a second wall surface 111b, which will be described below, of the flat plate-shaped electric connection part 111 is disposed facing one of the facing wall surfaces 21a and 22a of the respective first end parts 21b and 22b, and the other of the first wall surface 111a and the second wall surface 111b is disposed facing the other of the facing wall surfaces 21a and 22a. In other words, the first electric connection part 21 and the second electric connection part 22 are formed and disposed so that the first wall surface 111a and the second wall surface 111b can be disposed facing either of the facing wall surfaces 21a and 22a. In this example, the facing wall surfaces 21a and 22a, and the first and the second wall surfaces 111a and 111b are disposed facing each other in parallel.

In the terminal metal fitting 20, the first electric connection part 21 and the second electric connection part 22 are coupled by the joining part 23 (from FIG. 1 to FIG. 3). The joining part 23 couples first side end parts of second end parts 21c and 22c of the respective first and second electric connection parts 21 and 22. The joining part 23 is a portion connected to the first side end parts of the first electric connection part 21 and the second electric connection part 22, and is formed by bending the terminal metal fitting 20X before being bent such that the first electric connection part 21X and the second electric connection part 22X are disposed facing each other.

In the first and the second electric connection parts 21 and 22, force in a direction to expand the interval between the facing wall surfaces 21a and 22a is applied from the electric connection part 111 when the electric connection part 111 is inserted between the first end parts 21b and 22b. In the first and the second electric connection parts 21 and 22, when the interval between the facing wall surfaces 21a and 22a expands too much, it is difficult to obtain nipping force (in other words, holding force) for the electric connection part 111. On the other hand, in the first and the second electric connection parts 21 and 22, when the interval between the facing wall surfaces 21a and 22a of the respective first end parts 21b and 22b cannot be expanded, force applied when inserting and extracting the electric connection part 111 becomes excessive, and it is difficult to improve inserting and extracting workability of the electric connection part 111.

Thus, the terminal metal fitting 20 is provided with the opening restriction part 24 capable of allowing the expansion of the interval between the facing wall surfaces 21a and 22a of the respective first end parts 21b and 22b, while reducing the insertion and extraction force for the electric connection part 111 and securing the holding force for the electric connection part 111 (from FIG. 1 to FIG. 3). The opening restriction part 24 is a portion for keeping the interval between the facing wall surfaces 21a and 22a of respective second end parts 21c and 22c in the first and the second electric connection parts 21 and 22. Consequently, the opening restriction part 24 allows expansion of the interval between the facing wall surfaces 21a and 22a of the respective first end parts 21b and 22b, while reducing the insertion and extraction force for the electric connection part 111 and securing the holding force for the electric connection part 111.

More particularly, the opening restriction part 24 is formed so as to be able to keep the interval between the facing wall surfaces 21a and 22a of the respective second end parts 21c and 22c in the first and the second electric connection parts 21 and 22, between the second side end parts of the respective second end parts 21c and 22c in the first and the second electric connection parts 21 and 22. The opening restriction part 24 is formed so as to project from the second side end part of the second end part 21c of the first electric connection part 21, and lock the second side end part by hooking to the second side end part of the second end part 22c of the second electric connection part 22.

The opening restriction part 24 can prevent the interval between the facing wall surfaces 21a and 22a of the respective second end parts 21c and 22c from expanding further, by locking the second side end part of the second end part 22c in the second electric connection part 22. On the other hand, the opening restriction part 24, together with the joining part 23, can make the first end parts 21b and 22b side of the respective first and second electric connection parts 21 and 22 to have flexibility.

Consequently, in the first end parts 21b and 22b, it is possible to expand the interval between the facing wall surfaces 21a and 22a of the respective first end parts 21b and 22b by the opening restriction part 24 and the joining part 23. The opening restriction part 24 can adjust the expanding amount of the interval between the facing wall surfaces 21a and 22a of the respective first end parts 21b and 22b by adjusting a locking area between the second side end parts of the respective second end parts 21c and 22c. For example, in the first and the second electric connection parts 21 and 22, the first end parts 21b and 22b side of the respective first and second electric connection parts 21 and 22 are prevented from becoming flexible by at least expanding the locking area provided by the opening restriction part 24 toward the respective first end parts 21b and 22b side. Consequently, it is possible to reduce the expansion amount of the interval between the facing wall surfaces 21a and 22a of the respective first end parts 21b and 22b. The expansion amount of the interval is reduced when the locking area provided by the opening restriction part 24 expands toward the first end parts 21b and 22b sides. The range of the locking area provided by the opening restriction part 24 is determined on the basis of the magnitude of a desired insertion and extraction force for the electric connection part 111 and the magnitude of a desired holding force for the electric connection part 111. To adjust the expansion amount, it is preferable to adjust the joining part 23 as well by adjusting the connection area of the first side end parts of the respective second end parts 21c and 22c on the basis of the same idea of adjusting the locking area provided by the opening restriction part 24.

The opening restriction part 24 in the example includes a locking part 24a and a bonding part 24b (from FIG. 1 to FIG. 3). The locking part 24a is disposed facing an outer side wall surface 22d placed opposite from the facing wall surface 22a of the second end part 22c in the second electric connection part 22, and locks the outer side wall surface 22d of the second side end part of the second end part 22c in the second electric connection part 22. The bonding part 24b couples the second side end part of the second end part 21c in the first electric connection part 21 with the locking part 24a. In this example, the locking part 24a and the bonding part 24b are formed as a piece.

In the terminal metal fitting 20, further expansion of the interval between the facing wall surfaces 21a and 22a of the respective second end parts 21c and 22c in the first and the second electric connection parts 21 and 22 is prevented because the outer side wall surface 22d is locked by the locking part 24a of the opening restriction part 24. In the terminal metal fitting 20, the first end parts 21b and 22b sides of the respective first and second electric connection parts 21 and 22 have flexibility while the further expansion of the of the interval between the facing wall surfaces 21a and 22a is prevented. Thus, when the electric connection part 111 is inserted between the first end parts 21b and 22b, it is possible to expand the interval between the facing wall surfaces 21a and 22a of the respective first end parts 21b and 22b. Consequently, in the terminal metal fitting 20, it is possible to insert the electric connection part 111 between the first end parts 21b and 22b with the insertion force reduced to a desired magnitude. Moreover, in the terminal metal fitting 20, it is possible to hold the electric connection part 111 with the holding force having a desired magnitude. Furthermore, in the terminal metal fitting 20, it is possible to extract the electric connection part 111 from between the first end parts 21b and 22b by the extraction force reduced to a desired magnitude.

In this example, the terminal metal fitting 20 includes the fixed part 25 fixed to the housing body 40 (from FIG. 1 to FIG. 3). The fixed part 25 is provided to one of the first electric connection part 21 and the second electric connection part 22. The fixed part 25 in the example is formed as a piece, and projects from an end portion of the second end part 21c of the first electric connection part 21 in the connector insertion and extraction direction. In this example, the fixed part 25 projects in the perpendicular direction with respect to the facing wall surface 21a of the first electric connection part 21. The fixed part 25 is formed with a through hole 25a through which a male screw member B1, which will be described below, is inserted.

The contact member 30 is fitted to each of the first electric connection part 21 and the second electric connection part 22 of the terminal metal fitting 20.

Different contact members 30 may be used for the first electric connection part 21 and the second electric connection part 22, or the same contact members 30 may be used for the first electric connection part 21 and the second electric connection part 22. In this example, the same contact members 30 are used for the first electric connection part 21 and the second electric connection part 22.

The contact members 30 are physically and electrically connected to the first electric connection part 21 and the second electric connection part 22 by being fitted to the first end parts 21b and 22b of the respective first electric connection part 21 and the second electric connection part 22. In other words, the connection terminal 10 includes a pair of combination of the first electric connection part 21 and one contact member 30 that are brought into contact with each other, and a pair of combination of the second electric connection part 22 and the other contact member 30 that are brought into contact with each other. Thus, the contact member 30 can be brought into contact with the first wall surface 111a or the second wall surface 111b of the electric connection part 111 that is inserted between the first end parts 21b and 22b of the first and the second electric connection parts 21 and 22. Consequently, the contact members 30 can electrically connect the electric connection part 111 to the first electric connection part 21 and the second electric connection part 22.

The contact members 30 are formed of a conductive material such as metal (copper, copper alloy, aluminum, aluminum alloy, and the like) to have a spring property. In this example, the contact members 30 are formed by press working such as cutting and bending, using a conductive metal sheet as a base material.

The contact members 30 are formed so that the first electric connection part 21 and the second electric connection part 22 are fitted into the respective contact members 30. Consequently, the contact members 30 are formed in a ring shape or a tube shape. For example, each contact member 30 in the example includes two ring-shaped parts 31 formed in a rectangular tube shape and four joining parts 32 (FIG. 1 and FIG. 2). The ring-shaped parts 31 are disposed facing each other at an interval while aligning in the tube axis direction. The joining parts 32 each couple the ring-shaped parts 31. The first end part 21b of the first electric connection part 21 and the first end part 22b of the second electric connection part 22 are fitted into the respective ring-shaped parts 31. For example, the joining parts 32 are disposed at respective corners of the two ring-shaped parts 31, and join the corners facing each other in the tube axis direction.

Moreover, each contact member 30 includes, between the ring-shaped parts 31, at least one contact part 33 that projects outward than each of the ring-shaped parts 31 and that has flexibility (FIG. 1 and FIG. 2). The contact member 30 in the example includes a plurality of the contact parts 33 projecting in the same direction at the same projecting amount. Both ends of each contact part 33 in the tube axis direction are joined to each of the ring-shaped parts 31, and a curved surface provided at the maximum projecting position at the center in the tube axis direction is set as a contact point. The contact parts 33 form a virtual plane surface (not illustrated) by coupling the maximum projecting positions. The virtual plane surface in the example is disposed facing the facing wall surfaces 21a or 22a in a parallel state when the first electric connection part 21 or the second electric connection part 22 is fitted.

In the connector 1, the first electric connection part 21 and the second electric connection part 22 are fitted into the respective contact members 30 so that the virtual plane surfaces are disposed facing each other at an interval in a parallel state. Consequently, the contact parts 33 of the respective contact members 30 are disposed facing each other in the perpendicular direction with respect to the facing wall surfaces 21a and 22a of the respective first electric connection part 21 and the second electric connection part 22. The interval between the virtual plane surfaces is made narrower than the plate thickness of the electric connection part 111.

Consequently, by inserting the electric connection part 111 between the contact members 30, the contact parts 33 can be brought into contact with the first wall surface 111a and the second wall surface 111b of the electric connection part 111. Consequently, the first electric connection part 21 and the second electric connection part 22 are physically and electrically connected to the electric connection part 111 via the contact members 30 in a terminal housing chamber 141 of a second housing member 140 of a casing 120, which will be described below.

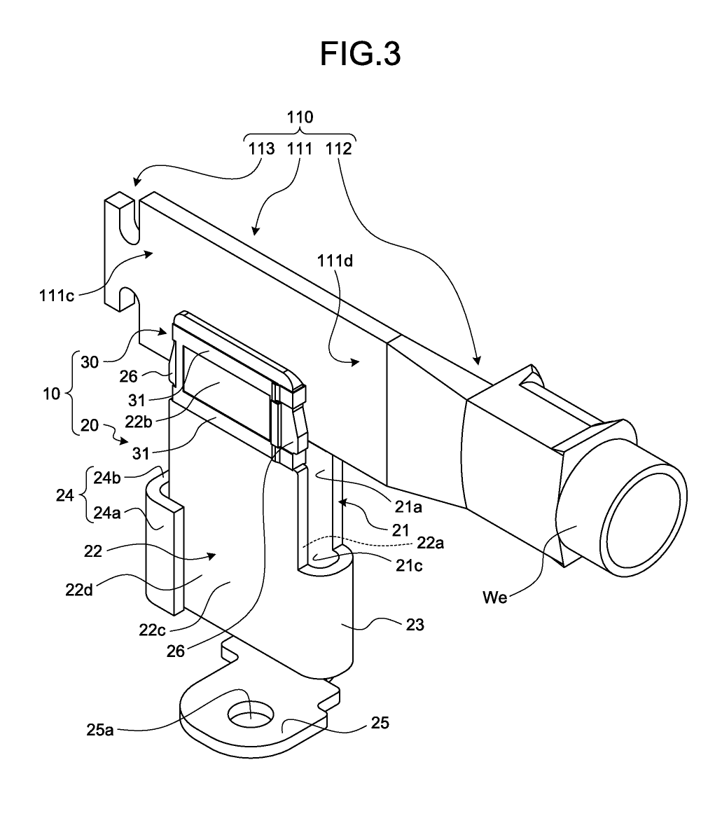

In this example, the first electric connection part 21 and the second electric connection part 22 in the example each include, at each side end part of the first end parts 21b and 22b, a locking projection 26 for holding the contact member 30 after being fitted (FIG. 1 and FIG. 2). The contact member 30 in the example includes locking holes 34 into which the locking projection 26 of each side end part of the first end part 21b in the first electric connection part 21 or the locking projection 26 of each side end part of the first end part 22b in the second electric connection part 22 is inserted (FIG. 1 or FIG. 2). The locking projections 26 lock the ring-shaped parts 31 at the respective second end parts 21c and 22c side of the contact member 30 after being fitted (FIG. 3).

Consequently, the contact member 30 is held by the first electric connection part 21 or the second electric connection part 22 after the first end part 21b or 22b of the first electric connection part 21 or the second electric connection part 22 is fitted into the contact member 30.

In the connection terminal 10, the locking area provided by the opening restriction part 24 is adjusted while taking into account the spring force of the contact parts 33 of the contact members 30.

The connection terminal 10 is housed in the housing body 40 (FIG. 4 and FIG. 5). The housing body 40 includes a housing member 50 (from FIG. 4 to FIG. 7) that houses the connection terminal 10, and a holding member 60 (from FIG. 4 to FIG. 6) that prevents the housed connection terminal 10 from coming off the housing member 50.

The housing member 50 is formed of an insulating material such as synthetic resin. The housing member 50 includes a first housing body 51 and a second housing body 52. The first housing body 51 houses the pair of combination of the first electric connection part 21 and one contact member 30. The second housing body 52 houses the pair of combination of the second electric connection part 22 and the other contact member 30 (from FIG. 4 to FIG. 7). The first housing body 51 is formed so as to surround the first electric connection part 21 and the one contact member 30 while exposing the facing wall surface 21a and the contact part 33 side of the one contact member 30. The second housing body 52 is formed so as to surround the second electric connection part 22 and the other contact member 30 while exposing the facing wall surface 22a and the contact part 33 side of the other contact member 30. The first housing body 51 and the second housing body 52 are disposed facing each other at an interval in the perpendicular direction with respect to the respective facing wall surfaces 21a and 22a. The size of the interval is set such that the electric connection part 111 is not prevented from being inserted between the contact members 30. The housing member 50 includes a pair of the first housing body 51 and the second housing body 52 for each connection terminal 10.

The housing member 50 includes a tube body 53 the tube axis direction of which is the connector insertion and extraction direction, and both ends of which in the tube axis direction are opened (from FIG. 4 to FIG. 7). All combinations of the first housing body 51 and the second housing body 52 extend in the connector insertion direction from the inner space of the tube body 53, and project from an opening 53a at one end of the tube body 53 (FIG. 4, FIG. 6, and FIG. 7). An insertion port 53c through which the connection terminal 10 is inserted is provided at an opening 53b of the other end of the tube body 53 for each connection terminal 10 (FIG. 5). A holding part 53d for holding the first housing body 51 and the second housing body 52, and for holding the connection terminal 10 is provided inside the tube body 53 (FIG. 5). The connection terminal 10 is fixed to the holding part 53d via the male screw member B1 inserted into the through hole 25a. A female screw member N1 into which the male screw member B1 is to be screwed is inserted into and engaged with the holding part 53d (FIG. 5).

A flange part 54 for fixing the housing member 50 to the casing 201 of the power supply circuit 200 is provided outside of the tube body 53 (from FIG. 4 to FIG. 7). The flange part 54 includes a through hole 54a through which a male screw member B2 is inserted (from FIG. 4 to FIG. 6). The flange part 54 is fixed to the casing 201 via the male screw member B2 (FIG. 7). A female screw member N2 into which the male screw member B2 is to be screwed is formed in the casing 201 (FIG. 6).

In the tube body 53, a portion at the connector insertion direction side than the flange part 54 (in other words, a portion projecting from the casing 201) is an engaging part (connector engaging part) 53e with a connector engaging part 131a, which will be described below, of the casing 120 of the counterpart connector 101 (from FIG. 4 to FIG. 7). A seal member Se1 formed in a ring shape is fitted to the outer peripheral surface of the connector engaging part 53e. The connector engaging part 53e is inserted into and engaged with the connector engaging part 131a. The seal member Se1 is interposed between the connector engaging part 53e and the connector engaging part 131a, and is brought into close contact with the wall surfaces of the connector engaging part 53e and the connector engaging part 131a. A portion at the connector extraction direction side than the flange part 54 of the tube body 53 (in other words, a portion buried in the casing 201) is an engaging part 53f with the holding member 60 (FIG. 4 and FIG. 5).

The holding member 60 is formed of an insulating material such as synthetic resin. The holding member 60 is engaged with the engaging part 53f at the opening 53b side of the other end of the tube body 53, and blocks the insertion port 53c of the connection terminal 10. The engaging part 53f is inserted into and engaged with the holding member 60. In the connector 1, the holding member 60 is an engaging part with the casing 201. Consequently, a seal member Se2 formed in a ring shape is fitted to the outer peripheral surface of the holding member 60 (FIG. 4 and FIG. 5).

In this manner, the connector 1 described above is inserted into and engaged with the counterpart connector 101, and is electrically connected to the counterpart connector 101. In the following, an example of the counterpart connector 101 will be described.

The counterpart connector 101 of the present embodiment may be configured as a shield connector that prevents noise entering from outside. In the following example, the counterpart connector 101 configured as a shield connector will be described.

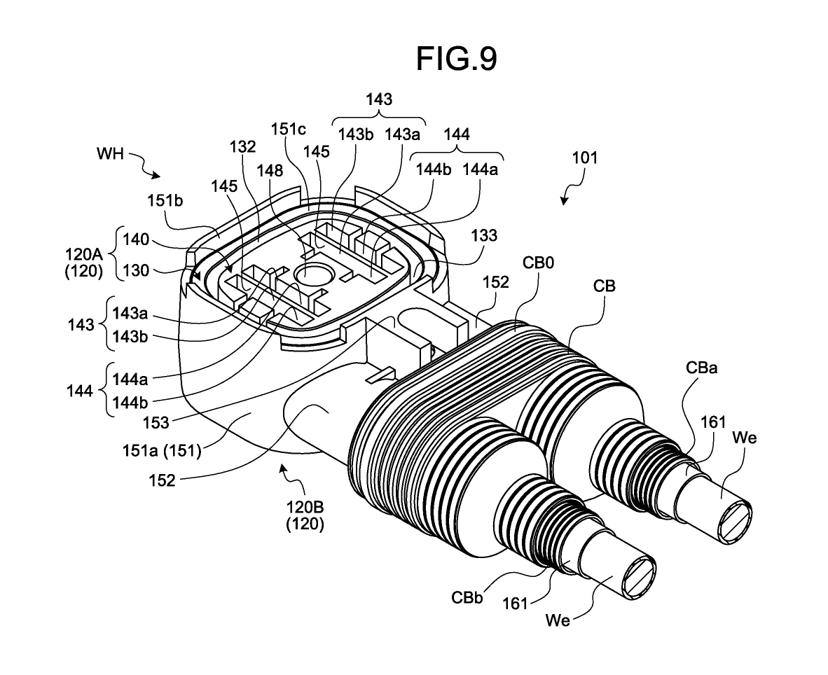

The counterpart connector 101 of the present embodiment is physically and electrically connected to the electric wire We, and constitutes together with the electric wire We an electric wire WH with a connector (FIG. 7, and from FIG. 9 to FIG. 11).

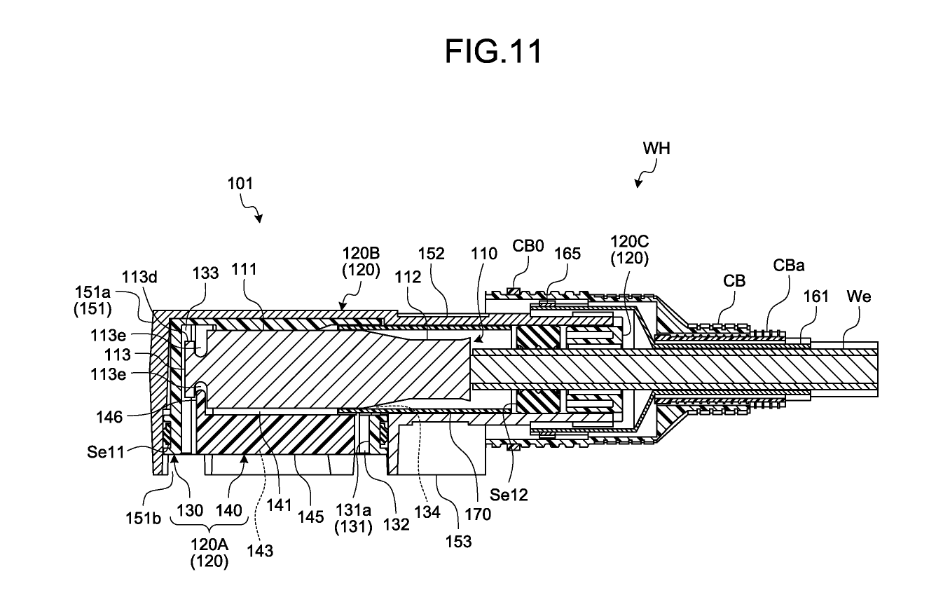

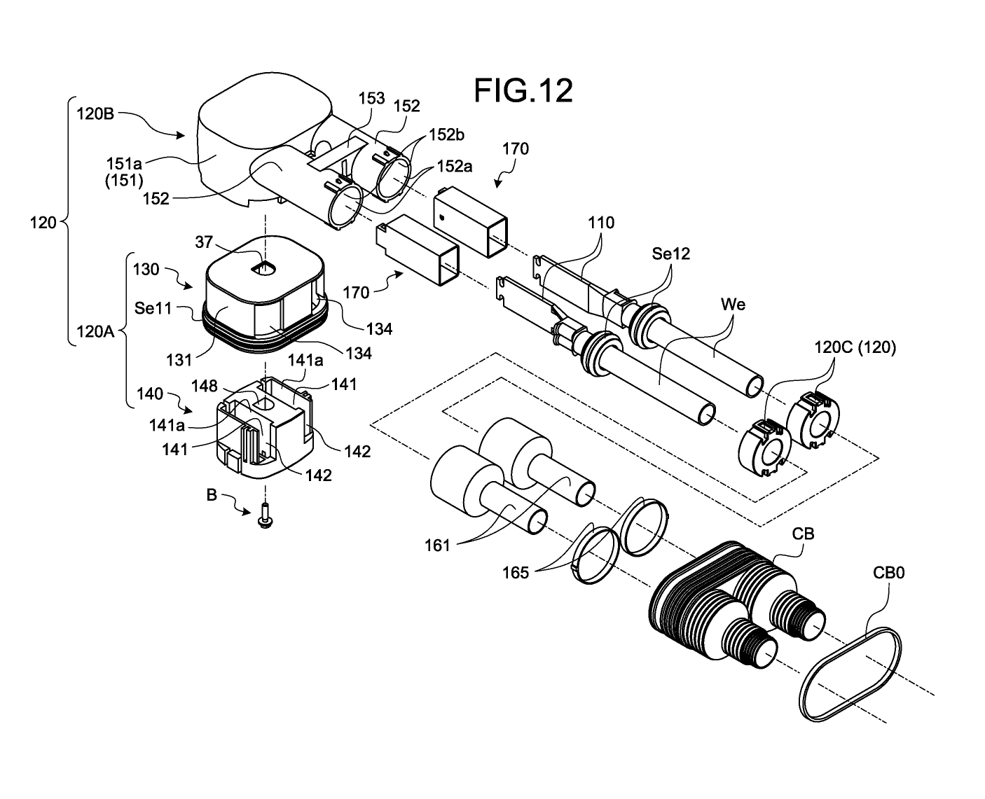

The counterpart connector 101 includes the counterpart connection terminal 110 electrically connected to the connection terminal 10, and the casing 120 that houses the counterpart connection terminal 110 (FIG. 11 and FIG. 12).

The counterpart connection terminal 110 of the present embodiment is provided for each connection terminal 10. The counterpart connector 101 in the example includes two counterpart connection terminals 110. In this example, the terminal metal fitting is used as the counterpart connection terminal 110. In the counterpart connector 101, a plurality of the same counterpart connection terminals 110 are provided in the casing 120. However, the counterpart connectors 101 may include a combination of the counterpart connection terminal 110 in the example and a counterpart connection terminal (terminal metal fitting) having a different shape from that of the counterpart connection terminal 110 in the example.

The counterpart connection terminal 110 is a male counterpart terminal metal fitting, and is formed of a conductive material such as metal (copper, copper alloy, aluminum, aluminum alloy, and the like). In this example, the male counterpart connection terminal 110 is formed by press working such as cutting and bending, using a conductive metal sheet as a base material.

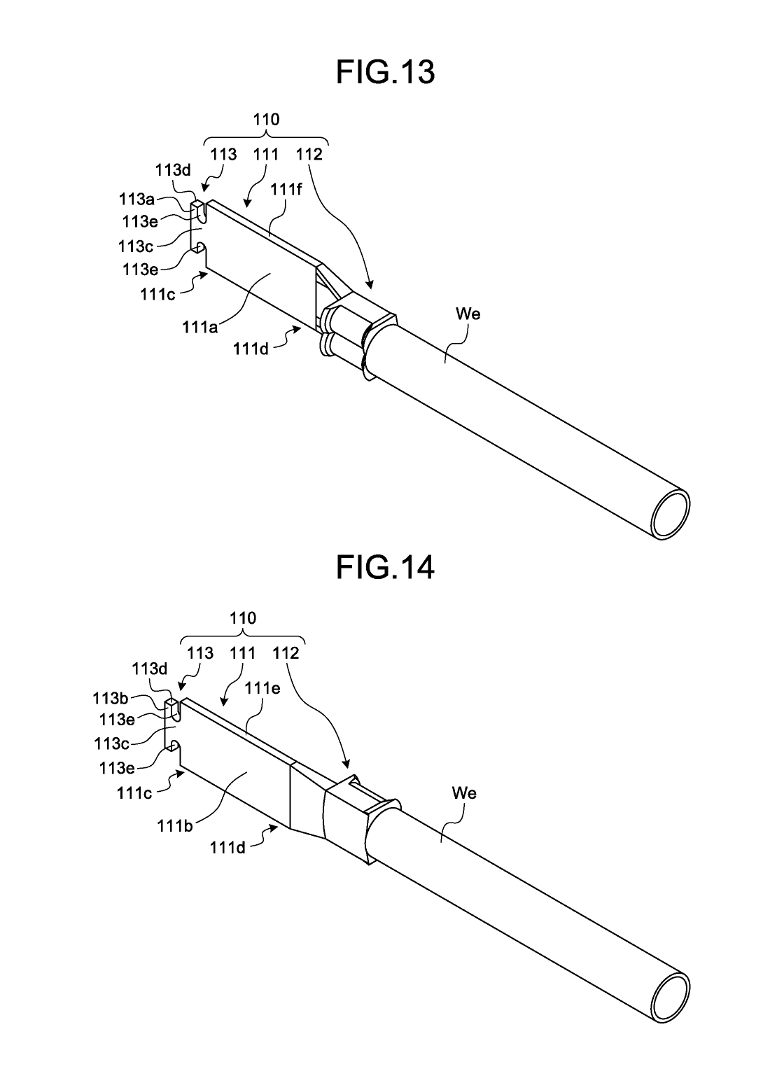

The counterpart connection terminal 110 includes the electric connection part 111 electrically connected to the connection terminal 10, and an electric wire connection part 112 electrically connected to the terminal of the electric wire We (FIG. 11, and from FIG. 13 to FIG. 16).

The electric connection part 111 in the example is formed in a male shape. The electric connection part 111 in the example is formed in a flat plate shape having two flat wall surfaces (the first wall surface 111a and the second wall surface 111b) (FIG. 16). In this example, the electric connection part 111 is formed in a rectangular flat plate shape, and the first wall surface 111a and the second wall surface 111b are disposed facing each other in parallel. In the electric connection part 111, at least one of the first wall surface 111a and the second wall surface 111b is used as a contact part at which the electric connection part 111 is physically and electrically connected to the connection terminal 10. In this example, as described above, the connection terminal 10 includes two electric connection parts (the first electric connection part 21 and the second electric connection part 22). Consequently, the first wall surface 111a and the second wall surface 111b are both used as the contact parts to electrically connect to the two electric connection parts.

The electric wire connection part 112 in the example is physically and electrically connected to the terminal of the electric wire We. The electric wire connection part 112 may be crimped to the terminal of the electric wire We with a swage and the like, or may be firmly fixed to the terminal of the electric wire We by welding and the like. The electric wire connection part 112 in the example is crimped to the terminal of the electric wire We.

In the counterpart connection terminal 110 in the example, a first end part 111c and a second end part 111d of the electric connection part 111 are disposed facing each other. The first end part 111c side of the electric connection part 111 is the tip end and the electric wire connection part 112 is disposed at the second end part 111d side of the electric connection part 111 (from FIG. 13 to FIG. 16).

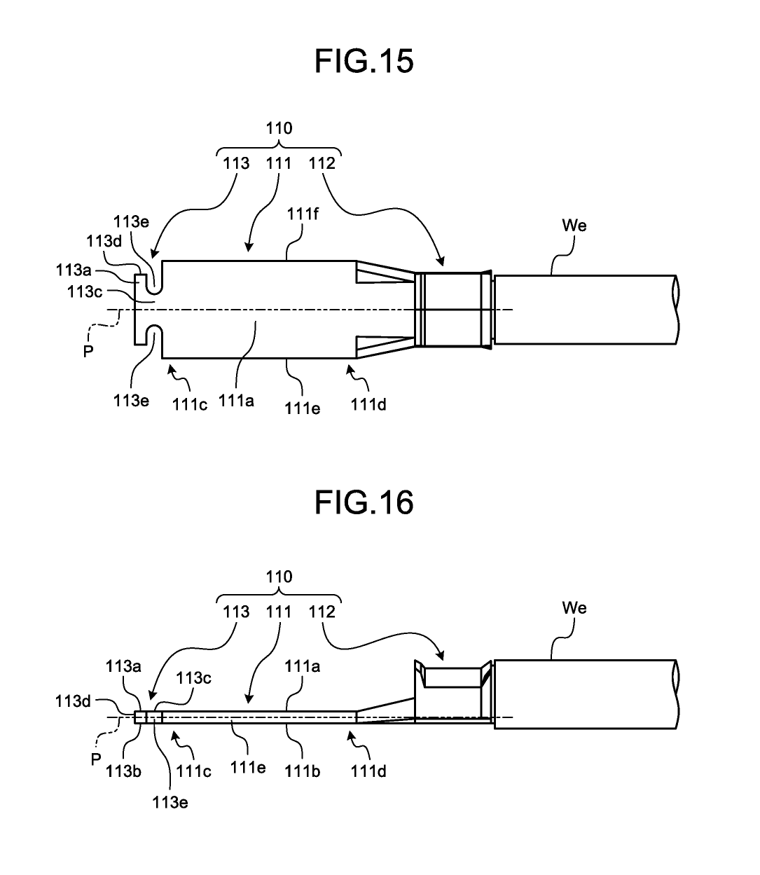

The counterpart connection terminal 110 in the example includes a virtual axis P extending along an axis direction of the terminal of the electric wire We that is physically and electrically connected to the electric wire connection part 112 (FIG. 15 and FIG. 16). A held part 113, which will be described below, the electric connection part 111, and the electric wire connection part 112 are disposed in this order from the tip end of the counterpart connection terminal 110 along the virtual axis P.

More specifically, the electric connection part 111 extends in a direction along the virtual axis P (hereinafter, simply referred to as an “axis direction”). One end of the electric connection part 111 in the axis direction is the first end part 111c described above, and the other end of the electric connection part 111 in the axis direction is the second end part 111d described above (FIG. 15 and FIG. 16). The electric connection part 111 includes two end surfaces (a first end surface 111e and a second end surface 111f) that are disposed facing each other and that are different from the two end parts 111c and 111d disposed facing each other (FIG. 15). The first end surface 111e and the second end surface 111f are disposed facing each other in parallel, in the direction perpendicular to the axis direction of the counterpart connection terminal 110 and in the perpendicular direction with respect to the first and the second wall surfaces 111a and 111b. In the electric connection part 111, the first end surface 111e side and the second end surface 111f side around the virtual axis P have the same substantially rectangular flat plate shapes.

Next, the casing 120 of the present embodiment will be described.

The casing 120 of the present embodiment includes a housing body 120A that houses the counterpart connection terminal 110 (from FIG. 9 to FIG. 12). Moreover, the casing 120 of the present embodiment includes a shield shell 120B that houses therein a part from the housing body 120A to the terminal of the electric wire We and that covers the part from the outside (FIG. 7, and from FIG. 9 to FIG. 12). Furthermore, the casing 120 of the present embodiment includes a holding member 120C that prevents the counterpart connection terminal 110 from coming off the housing body 120A at the electric wire We side (FIG. 11 and FIG. 12).

First, the housing body 120A will be described.

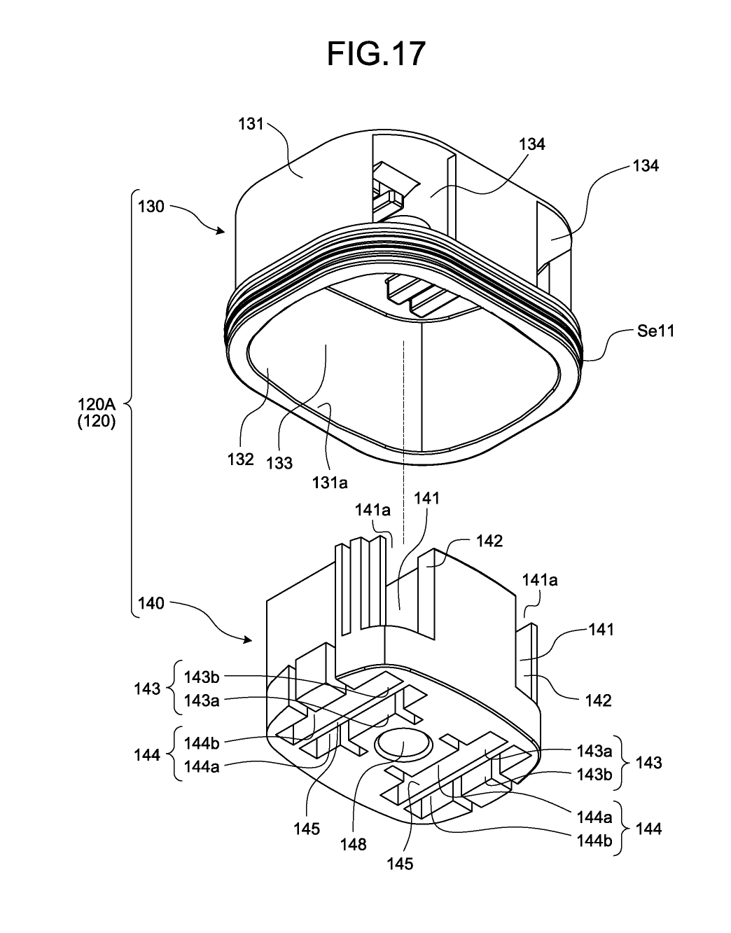

The housing body 120A is formed of an insulating material such as synthetic resin. The housing body 120A houses the electric connection part 111 in a housing space 133, which will be described below, and allows the electric wire connection part 112 to project to the outside. The housing body 120A of the present embodiment is roughly divided into a first housing member 130 and the second housing member 140 (from FIG. 9 to FIG. 12, and FIG. 17).

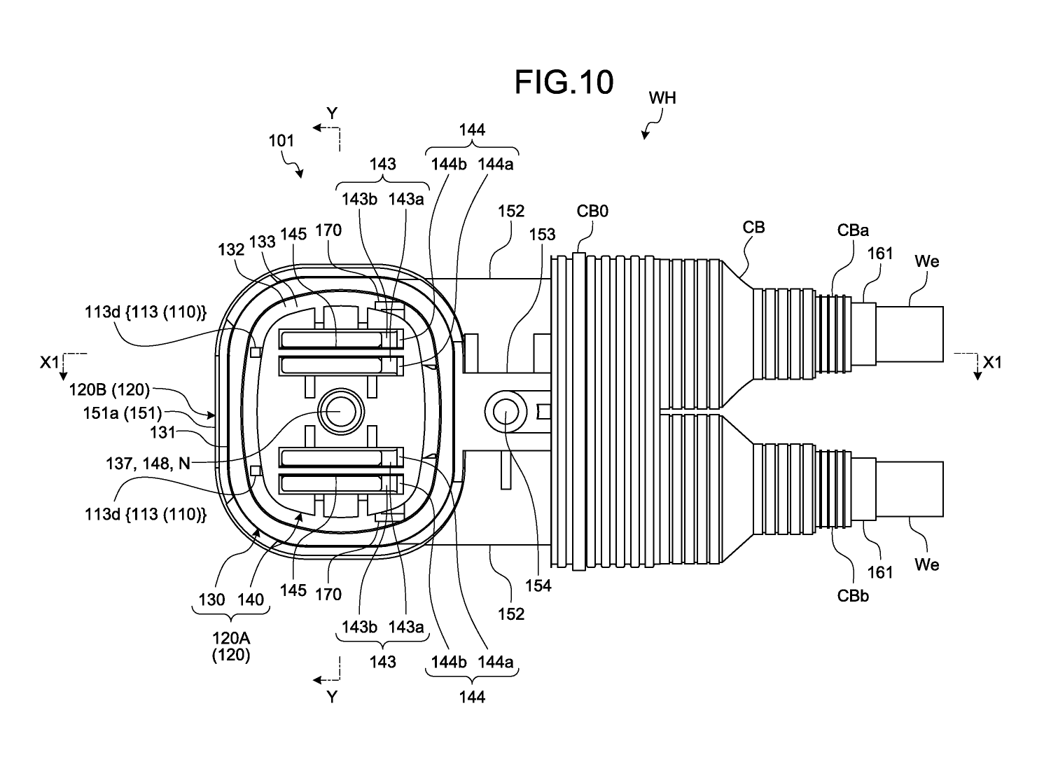

The first housing member 130 is formed in a tube body shape, at least one end of which in the tube axis direction is opened. Thus, the first housing member 130 includes a tube-shaped outer peripheral wall 131 (from FIG. 10 to FIG. 12, and FIG. 17). The outer peripheral wall 131 of the first housing member 130 in the example is formed in a rectangular tube shape, and one end of the first housing member 130 in the tube axis direction is opened, and the other end of the first housing member 130 is closed. The connection terminal 10 is inserted, from the opening 132 at the one end (FIG. 9, FIG. 11, and FIG. 17), into the housing space 133 (FIG. 9, FIG. 11, and FIG. 17) provided inside the first housing member 130 along the tube axis direction. However, strictly speaking, as described below, the connection terminal 10 is inserted into the housing space 133 from the opening 132 via the second housing member 140.

The end part of the outer peripheral wall 131 at the opening 132 side is the engaging part (connector engaging part) 131a with the connector engaging part 53e of the connector 1 (FIG. 11 and FIG. 17). The connector engaging part 53e is inserted into and engaged with the connector engaging part 131a. A ring-shaped seal member Se11 is concentrically fitted to the outer peripheral surface of the connector engaging part 131a (FIG. 11, FIG. 12, and FIG. 17).

The outer peripheral wall 131 includes an insertion hole 134 through which the counterpart connection terminal 110 is inserted into the housing space 133 from the tip end at the electric connection part 111 side (FIG. 11, FIG. 12, and FIG. 17). The first housing member 130 in the example houses the electric connection part 111 in the housing space 133 provided inside, and allows the electric wire connection part 112 to project to the outside from the insertion hole 134 (FIG. 11).

In this example, the insertion hole 134 is provided for each counterpart connection terminal 110. Consequently, two insertion holes 134 are formed on the outer peripheral wall 131 in the example (FIG. 12 and FIG. 17). The insertion holes 134 are formed and disposed so that the counterpart connection terminals 110 are inserted such that the axis directions are aligned in the same direction. In other words, in this example, the axis direction of the counterpart connection terminal 110 is the insertion direction of the counterpart connection terminal 110 into the housing space 133 (hereinafter, referred to as a “terminal insertion direction”). Moreover, each insertion hole 134 is formed and disposed so that the corresponding counterpart connection terminal 110 is inserted while the first and the second end surfaces 111e and 111f of the electric connection part 111 are directed in the tube axis direction of the outer peripheral wall 131 (in other words, while the first and the second wall surfaces 111a and 111b of the electric connection part 111 extend along the tube axis direction of the outer peripheral wall 131).

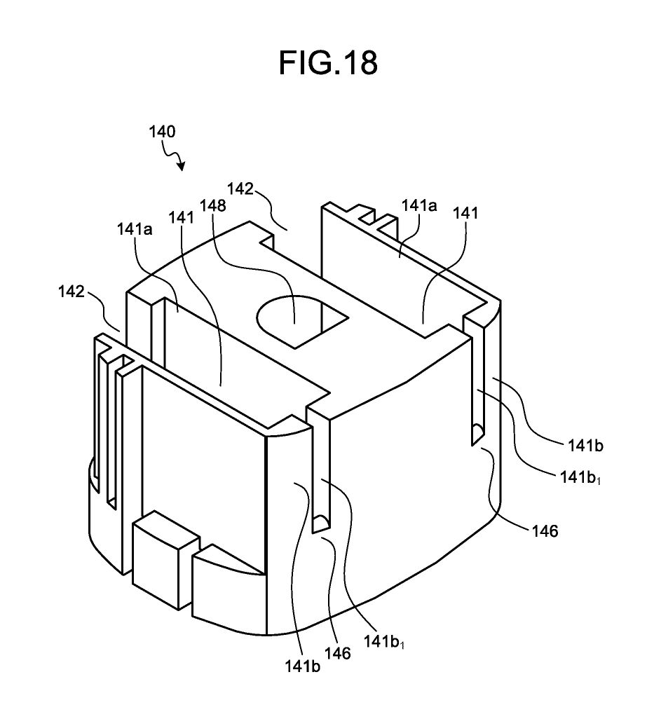

The second housing member 140 is formed into a polyhedron corresponding to the shape of the housing space 133 of the first housing member 130 (FIG. 17 and FIG. 18). The second housing member 140 is housed in the housing space 133 along the tube axis direction from the opening 132 of the first housing member 130 (FIG. 9, FIG. 11, FIG. 12, and FIG. 17). The second housing member 140 houses therein the electric connection part 111 of the counterpart connection terminal 110 in a state in which the second housing member 140 is already housed in the housing space 133 (FIG. 11).

The second housing member 140 includes the terminal housing chamber 141 that houses the electric connection part 111 in the housing space 133 (FIG. 11, FIG. 12, and from FIG. 17 to FIG. 19). As the second housing member 140 is inserted into the housing space 133, the terminal housing chamber 141 starts housing from an opening 141a the electric connection part 111 that is housed in the housing space 133 (FIG. 12, FIG. 17, and FIG. 18). The housing of the electric connection part 111 in the terminal housing chamber 141 is completed when the housing of the second housing member 140 into the housing space 133 is complete. Consequently, the second housing member 140 includes a notch 142 that communicates the terminal housing chamber 141 with the outside of the second housing member 140 at the outer peripheral surface side (FIG. 12, FIG. 17, and FIG. 18). The electric wire connection part 112 projects to the outside of the second housing member 140 from the notch 142. The notch 142 is disposed facing the insertion hole 134 while the second housing member 140 is housed in the housing space 133 so that the electric wire connection part 112 projects to the outside from the insertion hole 134 of the first housing member 130.

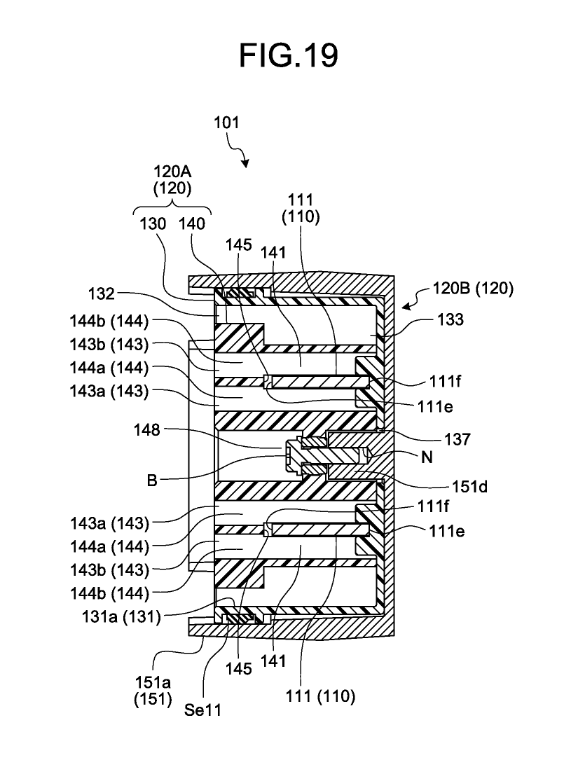

When the connector 1 and the counterpart connector 101 are engaged (hereinafter, referred to as “connector engagement”), the first and the second electric connection parts 21 and 22 of the connection terminal 10 and the two contact members 30 are housed in the terminal housing chamber 141. In the terminal housing chamber 141, the contact members 30 come into contact with the respective first wall surface 111a and the second wall surface 111b of the electric connection part 111, and physically and electrically connect the contact members 30 and the respective first wall surface 111a and the second wall surface 111b. Thus, the second housing member 140 includes a terminal insertion port 143 through which the connection terminal 10 is inserted into the terminal housing chamber 141 (FIG. 9, FIG. 10, FIG. 17, and FIG. 19). The terminal insertion port 143 is formed so that the second housing member 140 is disposed at the opening 132 side of the first housing member 130 while the second housing member 140 is housed in the housing space 133. The terminal insertion port 143 is disposed facing the terminal housing chamber 141 in the tube axis direction of the outer peripheral wall 131. Consequently, one of the first end surface 111e and the second end surface 111f of the electric connection part 111 housed in the housing space 133 is disposed facing the terminal insertion port 143.

The second housing member 140 includes a communication chamber 144 that communicates the terminal housing chamber 141 with the terminal insertion port 143 in the tube axis direction of the outer peripheral wall 131 (FIG. 9, FIG. 10, FIG. 17, and FIG. 19). Consequently, when the electric connection part 111 is housed in the terminal housing chamber 141, one of the first end surface 111e and the second end surface 111f is disposed facing the terminal insertion port 143 via the communication chamber 144.

The communication chamber 144 is provided with a partition wall 145 (from FIG. 9 to FIG. 11, FIG. 17, and FIG. 19). The partition wall 145 is formed in a flat plate shape having two flat wall surfaces, and is formed in the communication chamber 144 such that the two wall surfaces extend along the tube axis direction of the outer peripheral wall 131. In this example, the partition wall 145 is formed in a rectangular flat plate shape. The partition wall 145 is disposed so that the communication chamber 144 is divided into two chambers in the perpendicular direction with respect to the first and the second wall surfaces 111a and 111b of the electric connection part 111. In other words, the communication chamber 144 is divided into a first divided communication chamber 144a and a second divided communication chamber 144b by the partition wall 145 in the perpendicular direction (FIG. 9, FIG. 10, FIG. 17, and FIG. 19). Moreover, in this example, the terminal insertion port 143 is divided into a first divided insertion port 143a and a second divided insertion port 143b by the partition wall 145 in the perpendicular direction (FIG. 9, FIG. 10, FIG. 17, and FIG. 19). Consequently, the first electric connection part 21 of the connection terminal 10 is inserted into the terminal housing chamber 141 via the first divided insertion port 143a and the first divided communication chamber 144a. The second electric connection part 22 of the connection terminal 10 is inserted into the terminal housing chamber 141 via the second divided insertion port 143b and the second divided communication chamber 144b.

In this example, a pair of combination of the first electric connection part 21 and the one contact member 30 as well as the first housing body 51 are inserted from the first divided insertion port 143a into the first divided communication chamber 144a and then into the terminal housing chamber 141. In the terminal housing chamber 141, the one contact member 30 comes into contact with the first wall surface 111a of the electric connection part 111, thereby electrically connecting the electric connection part 111 to the first electric connection part 21. Moreover, in this example, a pair of combination of the second electric connection part 22 and the other contact member 30 as well as the second housing body 52 are inserted from the second divided insertion port 143b into the second divided communication chamber 144b and then into the terminal housing chamber 141. In the terminal housing chamber 141, the other contact member 30 comes into contact with the second wall surface 111b of the electric connection part 111, and electrically connects the electric connection part 111 to the second electric connection part 22. Consequently, in the second housing member 140, the first divided insertion port 143a, the second divided insertion port 143b, the first divided communication chamber 144a, the second divided communication chamber 144b, and the partition wall 145 are formed and disposed so that the insertions described above can be made.

The second housing member 140 includes a terminal holding part 146 (FIG. 11 and FIG. 18) for holding the held part 113 (FIG. 10, FIG. 11, and from FIG. 13 to FIG. 16) of the counterpart connection terminal 110 so as to prevent the electric connection part 111 from coming off the terminal housing chamber 141. The terminal holding part 146 is formed to hold the held part 113 to prevent the electric connection part 111 from coming off the terminal housing chamber 141 (FIG. 11). The held part 113 and the terminal holding part 146 are formed and disposed so that the held part 113 and the terminal holding part 146 can hold at least one of the tip end side and the base end side of the counterpart connection terminal 110. However, in the counterpart connection terminal 110 in the example, the electric wire connection part 112 projects outside the housing body 120A. Consequently, the base end side of the counterpart connection terminal 110 serving as the installation location of the held part 113 is the end part 111d of the electric connection part 111 at the electric wire connection part 112 side. In this example, the held part 113 is formed at the tip end of the counterpart connection terminal 110 as an inserted part, for example. Moreover, the terminal holding part 146 is formed as an inserting part to be inserted into the housing space 133 of the second housing member 140 and to be inserted into the held part 113. The held part 113 and the terminal holding part 146 are formed so as to lock the movement of the counterpart connection terminal 110 relative to the housing space 133 in the terminal insertion direction, and the movement of the counterpart connection terminal 110 in the direction opposite from the terminal insertion direction.

More specifically, the held part 113 in the example is formed in a T-shape projecting from the tip end (the first end part 111c) of the electric connection part 111 along the virtual axis P. The held part 113 includes a first wall surface 113a (FIG. 13, FIG. 15, and FIG. 16) formed in a T-shape disposed on the same plane as that of the first wall surface 111a of the electric connection part 111, and a second wall surface 113b (FIG. 14 and FIG. 16) formed in a T-shape disposed on the same plane as that of the second wall surface 111b of the electric connection part 111. The held part 113 also includes an axis part 113c the center axis of which is disposed along the virtual axis P and that is formed in a T-shape, and an intersection part 113d that is orthogonal to the axis part 113c at the tip end of the axis part 113c (from FIG. 13 to FIG. 16). The held part 113 uses a notched groove 113e that is formed between the held part 113 and the first end part 111c of the electric connection part 111 as an inserted part (FIG. 11, and from FIG. 13 to FIG. 16). Two grooves 113e are formed around the virtual axis P.

The held part 113 in the example is formed so that shapes on both sides of the virtual axis P in the direction perpendicular to the axis direction are the same and in the perpendicular direction with respect to the first and the second wall surfaces 113a and 113b. Consequently, both grooves 113e of the held part 113 can be used as the inserted parts. For example, in the counterpart connection terminal 110, when the first end surface 111e is disposed facing the terminal insertion port 143 in the terminal housing chamber 141, one of the two grooves 113e is used as the inserted part. Moreover, in the counterpart connection terminal 110, when the second end surface 111f is disposed facing the terminal insertion port 143 in the terminal housing chamber 141, the other of the two grooves 113e is used as the inserted part.

The terminal holding part 146 is inserted into the groove 113e of the held part 113 while the second housing member 140 is housed in the housing space 133. In this example, a notched groove 141b₁ is formed on the wall part 141b of the terminal housing chamber 141. The groove 141b₁ is obtained by cutting off the wall part 141b along the tube axis direction of the outer peripheral wall 131 (FIG. 18). The terminal holding part 146 in the example uses, as the inserted part into the held part 113, a remaining portion of the wall part 141b the apex of which is the bottom side of the groove 141b₁. In the held part 113 and the terminal holding part 146 in the example, the engagement of the grooves 113e and 141b₁ begins, as the second housing member 140 is inserted into the housing space 133. In the held part 113 and the terminal holding part 146, the insertion of the remaining portion of the wall part 141b into the groove 113e is completed when the housing of the second housing member 140 into the housing space 133 is completed. Consequently, it is possible to hold the electric connection part 111 while the electric connection part 111 is housed in the terminal housing chamber 141.

In the second housing member 140, a combination of the terminal housing chamber 141, the notch 142, the terminal insertion port 143, the communication chamber 144, the partition wall 145, and the terminal holding part 146 is provided for each counterpart connection terminal 110. Each combination is disposed so that a plurality of the counterpart connection terminals 110 are housed such that the axis directions and the terminal insertion directions of the counterpart connection terminals 110 with respect to the housing space 133 are aligned in the same direction. In this example, two sets of the combinations are provided. One of the combinations is formed and disposed so that the electric connection part 111 of the counterpart connection terminal 110 is housed in the terminal housing chamber 141 while the first end surface 111e is disposed facing the terminal insertion port 143 (in other words, the first and the second wall surfaces 111a and 111b extend along the tube axis direction of the outer peripheral wall 131). The electric connection part 111 is inserted into this terminal housing chamber 141 from the first end surface 111e side. The other of the combinations is formed and disposed so that the electric connection part 111 of the counterpart connection terminal 110 is housed in the terminal housing chamber 141 while the second end surface 111f is disposed facing the terminal insertion port 143 (in other words, the first and the second wall surfaces 111a and 111b extend along the tube axis direction of the outer peripheral wall 131). The electric connection part 111 is inserted into this terminal housing chamber 141 from the second end surface 111f side.

Next, the shield shell 120B will be described.

The shield shell 120B is a first shield member that prevents noise entering from outside to a part from the housing body 120A in which the first housing member 130 and the second housing member 140 are assembled to the terminal of the electric wire We. The shield shell 120B houses therein the part from the housing body 120A to the terminal of the electric wire We and covers the part from the outside. The shield shell 120B is formed of a conductive material such as metal. The shield shell 120B includes a main shield body 151 and a sub-shield body 152. The main shield body 151 covers the housing body 120A from the outside while exposing the opening 132 side. The sub-shield body 152 covers the electric wire connection part 112 that projects outside of the housing body 120A from the insertion hole 134 and the terminal of the electric wire We from the outside (FIG. 7, and from FIG. 9 to FIG. 12).

The main shield body 151 includes an outer peripheral wall 151a one end of which is opened and the other end of which is closed, and that has a tube shape (FIG. 7, and from FIG. 9 to FIG. 12). The outer peripheral wall 151a in the example is formed in a rectangular tube shape corresponding to the outer shape of the first housing member 130 formed in a rectangular tube shape. In the main shield body 151, the first housing member 130 is inserted in a housing space 151c (FIG. 9) provided inside the main shield body 151 along the tube axis direction of the main shield body 151 and the first housing member 130, from an opening 151b at the one end (FIG. 9 and FIG. 11). The shield member Se11 closely comes into contact with the inner peripheral surface of the outer peripheral wall 151a, while the first housing member 130 is housed in the housing space 151c. Consequently, it is possible to improve the liquid-tightness between the connector engaging part 131a and the main shield body 151 (FIG. 11).

The sub-shield body 152 is provided for each counterpart connection terminal 110. Consequently, in this example, two of the sub-shield bodies 152 are provided. The sub-shield body 152 is formed in a tube shape both ends of which are opened. The sub-shield body 152 in the example is formed in a cylinder shape. In the shield shell 120B, the sub-shield body 152 projects outside of the main shield body 151 from the outer peripheral wall 151a of the main shield body 151. The sub-shield body 152 in the example projects such that the tube axis direction extends along the terminal insertion direction. In the sub-shield body 152, the counterpart connection terminal 110 is inserted into a housing space 152b provided inside the sub-shield body 152 from an opening 152a at the free end side (FIG. 12). The housing space 152b communicates to the housing space 151c of the main shield body 151. Consequently, the counterpart connection terminal 110 is inserted into the housing space 151c of the main shield body 151 via the housing space 152b of the sub-shield body 152 from the tip end, and is inserted into the housing space 133 via the insertion hole 134 of the first housing member 130.

The shield shell 120B includes a joining body 153 that couples the two sub-shield bodies 152 disposed in parallel (from FIG. 9 to FIG. 12). The joining body 153 in the example is interposed between the two sub-shield bodies 152. The joining body 153 includes a through hole 154 for fixing the counterpart connector 101 to the connector 1 side (FIG. 10). The through hole 154 will be described below.

In this example, a ring-shaped seal member Se12 is concentrically fitted to the terminal of the electric wire We (FIG. 11 and FIG. 12). The seal member Se12 closely comes into contact with the inner peripheral surface of the sub-shield body 152 while the electric connection part 111 is housed in the housing space 133. Consequently, it is possible to improve the liquid-tightness between the sub-shield body 152 and the electric wire We (FIG. 11).

An end part of the sub-shield body 152 at the opening 152a side is fitted to the holding member 120C (FIG. 12). The holding member 120C is formed so that the electric wire We disposed in the housing space 152b of the sub-shield body 152 can be pulled out to the outside. The holding member 120C is formed of a conductive material such as metal. The holding member 120C is provided for each counterpart connection terminal 110. In this example, two of the holding members 120C are provided.

In addition to including the shield shell 120B serving as the first shield member, the counterpart connector 101 includes a second shield member 161 electrically connected to the shield shell 120B (FIG. 7, and from FIG. 9 to FIG. 12). The second shield member 161 prevents noise entering from outside to the electric wire We, by covering the end part of the sub-shield body 152 at the opening 152a side and the electric wire We pulled out from the opening 152a from the outside. The second shield member 161 is formed in a tube shape, and is provided for each counterpart connection terminal 110. In this example, two of the second shield members 161 are provided. In the counterpart connector 101, the electric wire We is pulled out to the outside from the holding member 120C fitted to the opening 152a of the sub-shield body 152. Consequently, the second shield member 161 in the example is formed so that the end part of the sub-shield body 152 at the opening 152a side, the holding member 120C, and the electric wire We pulled out from the holding member 120C are covered from the outside. Consequently, the second shield member 161 can prevent noise entering from outside to the electric wire We that is pulled out from the holding member 120C. More specifically, the second shield member 161 in the example is provided as a braid in which a plurality of conductive strands are woven in a tube shape and in a mesh shape. Consequently, the second shield member 161 in the example has flexibility, and can follow the movement such as bending of the electric wire We provided inside. In the drawings, a specific shape (mesh and the like) of the second shield member 161 is omitted for the sake of drawing convenience.

The second shield member 161 is fixed to the sub-shield body 152 using a binding member (binding band 165) formed of a conductive material such as metal (FIG. 11 and FIG. 12). A binding member well known in the art is used for the binding band 165. For example, the binding band 165 is wrapped around the second shield member 161 and the end part of the sub-shield body 152 at the opening 152a side, over the second shield member 161. By fastening the binding band 165, the binding band 165 is formed in an annular shape. Thus, the binding band 165 fixes the second shield member 161 to the end part of the sub-shield body 152 at the opening 152a side.

In this manner, in the counterpart connector 101, as described above, the electric wire connection part 112 of the counterpart connection terminal 110 projects from the insulating housing body 120A, and the projecting electric wire connection part 112 is covered by the conductive sub-shield body 152. Consequently, in the counterpart connector 101, an insulation body is interposed between the conductive electric wire connection part 112 and the sub-shield body 152, thereby increasing the insulation distance therebetween (space distance and creeping distance). The counterpart connector 101 includes an insulating tube member (hereinafter, referred to as an “insulating tube”) 170 that covers the electric wire connection part 112 and the terminal of the electric wire We from the outside (from FIG. 10 to FIG. 12). The insulating tube 170 is formed of an insulating material such as synthetic resin.

The counterpart connector 101 covers the second shield member 161 from the outside using an exterior member CB (FIG. 7, and from FIG. 9 to FIG. 12). For example, the exterior member CB is a corrugated tube, a boot, and the like, and is formed of an insulating material such as synthetic resin. The exterior member CB in the example is formed so as to be bendable to increase the flexibility of the wiring path of the electric wire We. For example, the exterior member CB is provided with bendable tube parts CBa and CBb for each electric wire We pulled out from the holding member 120C (FIG. 7, FIG. 9, and FIG. 10). For example, the exterior member CB is fixed to the shield shell 120B by a binding band CB0.

In the counterpart connector 101, the first housing member 130 is housed in the housing space 151c of the main shield body 151, and the counterpart connection terminal 110 that is fitted to the terminal of the electric wire We and that is inserted into the insulating tube 170 is housed in the housing space 133 of the first housing member 130 from the tip end. In the counterpart connector 101, the second housing member 140 is inserted into the housing space 133 in the state described above. In the counterpart connector 101, the first housing member 130, the second housing member 140, and the shield shell 120B are fixed by a screw to keep the fixed state of the components. For example, a female screw part N the axis of which extends in the tube axis direction, is formed on the main shield body 151 in the example (FIG. 19). The first housing member 130, the second housing member 140, and the shield shell 120B are fixed by screwing a male screw member B (FIG. 12 and FIG. 19) into the female screw part N. A through hole 137 through which a boss part 151d (FIG. 19) formed in a cylinder shape having the female screw part N is to be inserted is formed on the first housing member 130 (FIG. 10, FIG. 12, and FIG. 19). Moreover, a through hole 148 into which the male screw member B is inserted is formed on the second housing member 140 (FIG. 10, FIG. 12, FIG. 18, and FIG. 19). The axes of the through holes 137 and 148 extend in the tube axis direction of the outer peripheral wall 131. The axis of the boss part 151d extends in the tube axis direction of the outer peripheral wall 151a. Consequently, the first housing member 130, the second housing member 140, and the shield shell 120B are joined by an axial force in the tube axis direction.

The counterpart connector 101 has the configuration as described above.

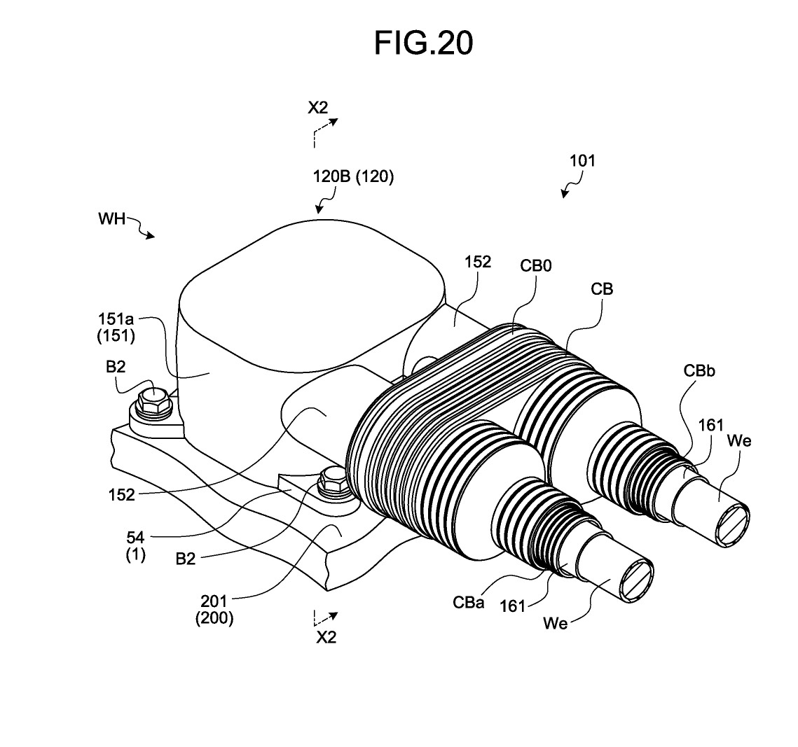

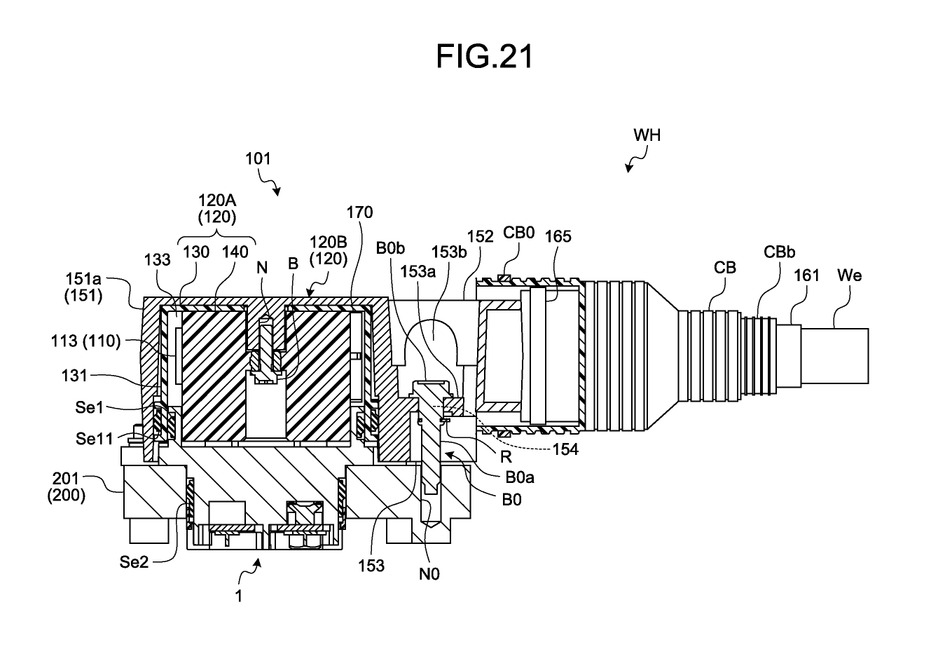

In this manner, the connector 1 is electrically connected to the counterpart connector 101 when the connector 1 is inserted into and engaged with the counterpart connector 101 (FIG. 20 and FIG. 21). The counterpart connector 101 of the present embodiment is fixed to the casing 201 with a screw, to keep the engaging state with the connector 1 (in other words, the electric connection state with the connector 1). In the example, by fixing the shield shell 120B to the casing 201 that is formed of a conductive material such as metal with a screw, the counterpart connector 101 is fixed to the casing 201, and the shield shell 120B and the second shield member 161 are electrically connected to the casing 201. It is to be noted that the casing 201 is grounded.

The counterpart connector 101 in the example uses the joining body 153 of the shield shell 120B as a holding body to be fixed to the casing 201. In the shield shell 120B in the example, the joining body 153 is interposed between the two sub-shield bodies 152, and the shield shell 120B is fixed to the casing 201 through the joining body 153.

For example, the through hole 154 through which a screw part B0a of a male screw member B0 (FIG. 7 and FIG. 21) is screwed is formed on the joining body 153 (FIG. 10 and FIG. 21). The axis of the through hole 154 is the tube axis direction of the outer peripheral wall 151a of the main shield body 151, and the through hole 154 is formed on a piece part 153a of the joining body 153 (FIG. 21). The wall surface of the piece part 153a forms a seat-surface of a head part B0b of the male screw member B0. In the example, a locking member R such as a C-ring is fitted to the screw part B0a side of the male screw member B0 so that the piece part 153a is interposed between the head part B0b and the locking member R (FIG. 7 and FIG. 21). The male screw member B0 is assembled to the joining body 153 so as to be able to rotate around the axis, by interposing the piece part 153a between the head part B0b and the locking member R. On the other hand, a female screw part NO is provided on the casing 201 (FIG. 6, FIG. 7, and FIG. 21). In this example, the male screw member B0 is screwed to the female screw part N0, while the engagement between the connector 1 and the counterpart connector 101 is completed. Consequently, the counterpart connector 101 can hold the engaging state with the connector 1 (electrically connected state with the connector 1). A work space 153b for inserting a tool such as a socket into the head part B0b and for rotating the head part B0b around the axis using the tool is formed in the joining body 153 (FIG. 21).

In the counterpart connector 101 of the present embodiment such as the above, the combination of the counterpart connection terminal 110, the electric wire We, the terminal housing chamber 141, the notch 142, the terminal insertion port 143, the communication chamber 144, the partition wall 145, the terminal holding part 146, the sub-shield body 152, the holding member 120C, the second shield member 161, and the insulating tube 170 is provided for each number of poles. In other words, the counterpart connector 101 may prepare the combination according to the number of poles. Consequently, the counterpart connector 101 allows easy design of the combination corresponding to a larger number of poles.

In this manner, in the connection terminal 10 of the present embodiment, the terminal metal fitting 20 includes the opening restriction part 24 described above.

Consequently, when the connector engagement is performed, it is possible to expand the interval between the facing wall surfaces 21a and 22a of the respective first end parts 21b and 22b in the first and the second electric connection parts 21 and 22, while reducing the insertion and extraction force of the electric connection part 111 and securing the holding force for the electric connection part 111. Because the connector 1 of the present embodiment includes the connection terminal 10, the connector 1 can have the same effect as that of the connection terminal 10.

In the example described above, the connection terminal 10 includes the terminal metal fitting 20 and the contact member 30. However, the connection terminal 10 may only include the terminal metal fitting 20, and the terminal metal fitting 20 may be used as the contact part. In this case, the contact part (not illustrated) may be provided in each of the first electric connection part 21 and the second electric connection part 22. For example, in this case, the first electric connection part 21 sets a bulging portion that is bulged from the facing wall surface 21a of the first end part 21b toward the facing wall surface 22a of the second electric connection part 22 as the contact part. Moreover, the second electric connection part 22 sets a bulging portion that is bulged from the facing wall surface 22a of the first end part 22b toward the facing wall surface 21a of the first electric connection part 21 as the contact part. For example, the contact parts each have a spherical surface serving as a contact point, and are disposed facing each other at an interval, in the perpendicular direction with respect to the respective facing wall surfaces 21a and 22a. The interval between the contact parts is set smaller than the plate thickness of the electric connection part 111. Thus, by inserting the electric connection part 111 between the first electric connection part 21 and the second electric connection part 22, the contact parts can be brought into contact with the first wall surface 111a and the second wall surface 111b of the electric connection part 111. Consequently, the first electric connection part 21 and the second electric connection part 22 can be physically and electrically connected to the electric connection part 111, in the terminal housing chamber 141 of the second housing member 140 of the casing 120.

In this example, when the connection terminal 10 includes the terminal metal fitting 20 and the contact member 30, the first electric connection part 21 and the second electric connection part 22 may each include the contact part (bulging part) described above, or does not necessarily include the contact part (bulging part) described above. When the first electric connection part 21 and the second electric connection part 22 include the contact part (bulging part), the connector 1 can commonly use the connection terminal 10 regardless of the presence of the contact member 30.

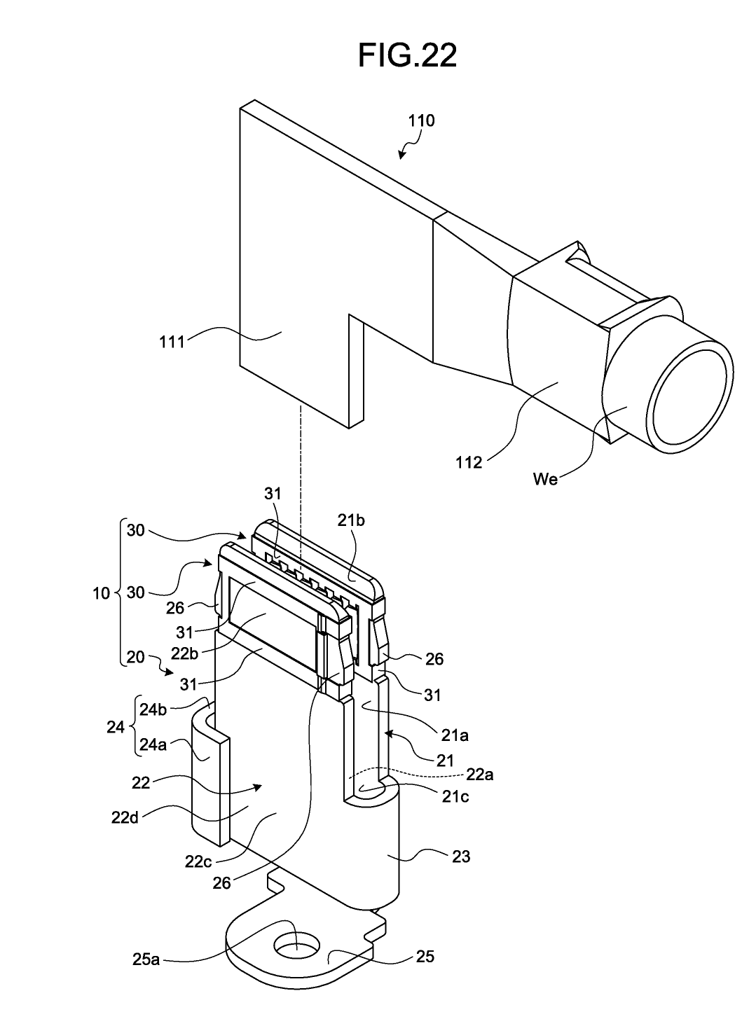

Moreover, in the counterpart connection terminal 110 in the example described above, the axis direction (in other words, the extending direction of the electric connection part 111) is orthogonal to the connector insertion and extraction direction. Consequently, the first end part 111c side and the second end part 111d side are protruded from between the first end parts 21b and 22b of the first and the second electric connection parts 21 and 22. However, for example, a piece at the tip end side between the two pieces forming an L-shape may be set as the electric connection part 111, and the counterpart connection terminal 110 serving as the counterpart of the connection terminal 10 of the present embodiment may be a portion that the electric connection part 111 is not protruded from between the first end parts 21b and 22b, or a portion obtained by subtracting the protruded amount of the electric connection part 111 from between the first end parts 21b and 22b (see FIG. 22).

In the connection terminal according to the present embodiment, the terminal metal fitting includes the opening restriction part. Consequently, when the connector engagement is performed, it is possible to expand the interval between the facing wall surfaces of the respective first end parts in the first and the second electric connection parts, while reducing the insertion and extraction force of the electric connection part of the counterpart connection terminal and securing the holding force for the electric connection part of the counterpart connection terminal. The connector according to the present embodiment includes the connection terminal, and can have the same effect as that of the connection terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connection terminal, comprising:
a terminal metal fitting that includes first and second electric connection parts each having facing wall surfaces disposed facing each other at an interval and formed in a flat plate shape, and that is electrically connected to an electric connection part of a counterpart connection terminal inserted between first end parts of the first and the second electric connection parts, wherein
the terminal metal fitting includes
a joining part that couples first side end parts of respective second end parts of the first and the second electric connection parts, and
an opening restriction part that keeps an interval between the facing wall surfaces of the respective second end parts of the first and the second electric connection parts between second side end parts of the respective second end parts of the first and the second electric connection parts.

2. The connection terminal according to claim 1, wherein
the opening restriction part is formed so as to project from the second side end part of the second end part of the first electric connection part, and lock the second side end part by being hooked to the second side end part of the second end part of the second electric connection part.

3. The connection terminal according to claim 1, further comprising:
a contact member that is attached to each of the first end parts of the first and the second electric connection parts, and that is capable of being brought into contact with a first wall surface or a second wall surface of the electric connection part of the counterpart connection terminal inserted between the first end parts of the first and the second electric connection parts.

4. The connection terminal according to claim 2, further comprising:
a contact member that is attached to each of the first end parts of the first and the second electric connection parts, and that is capable of being brought into contact with a first wall surface or a second wall surface of the electric connection part of the counterpart connection terminal inserted between the first end parts of the first and the second electric connection parts.

5. A connector, comprising:
a connection terminal; and
a housing body that houses the connection terminal in a housing space provided inside, wherein
the connection terminal includes a terminal metal fitting that includes first and second electric connection parts each having facing wall surfaces disposed facing each other at an interval and formed in a flat plate shape, and that is electrically connected to an electric connection part of a counterpart connection terminal inserted between first end parts of the first and the second electric connection parts, and
the terminal metal fitting includes a joining part that couples first side end parts of respective second end parts of the first and the second electric connection parts, and an opening restriction part that keeps an interval between the facing wall surfaces of the respective second end parts of the first and the second electric connection parts between second side end parts of the respective second end parts of the first and the second electric connection parts.
